(19) United States
(12) Patent Application Publication
(10) Pub. No.: US 2004/0217228 A1
(43) Pub. Date: Nov. 4, 2004

(54) Data transfer system

(75) Inventor: Jeffrey A. Scozzafava, Mays Landing, NJ (US)

Correspondence Address: MASON, MASON & ALBRIGHT, 2306 South Eads Street, P.O. Box 2246, Arlington, VA, 22202, US

(73) Assignee: Dimensions International Inc., Alexandria, VA

(21) Appl. No.: 10/387,589

(22) Filed: Mar. 14, 2003

Related U.S. Application Data
(60) Provisional application No. 60/363,930, filed on Mar. 14, 2002.

(51) Int. Cl. G05D 1/00

(52) U.S. Cl. 244/6; 701/3; 701/120

(57) ABSTRACT

An improved data transfer system is disclosed which provides efficient information retrieval for tracking subsets of aircraft which are within larger sets applicable in general to aircraft in route and selectively retrieving information in an automated manner which is user defined for information displayed and functionality and specific for a user defined subset of aircraft.

This application claims benefit of U.S. Provisional Patent Application No. 60/363,930 filed on Mar. 14, 2002.

### FIELD OF THE INVENTION

This invention relates to a system comprising computer software for tracking, positioning and transferring data that are relevant to an aircraft or a subset of aircraft during flights of the aircraft.

### BACKGROUND OF THE INVENTION

Computer software is currently used to track the position, statistics, and data relating to the progress of an aircraft before during and post route through data transfer systems, thereby providing users of said systems the ability to locate and access critical data that relates to the aircraft in route. Current systems in place for accessing data of aircraft in route do not, however, customize the search and retrieval of data in a manner which provides automated and readily accessible data pertinent and relevant to a particular subset of aircraft for access by different users and in which are in a quick visually perceptible format.

The prior art includes software which provides the ability to track the position, statistics, and progress of aircraft in route, which is currently available in the market under the trademark FLIGHTEXPLORER® version 2.2., 3.0 and 3.1. However, due to marked differences in individual users' needs, pertaining to aircraft fleet size, or nature of business associated with the aircraft industry, the currently available systems do not customize the retrieval of data for specific subsets of aircraft in route and for all users' specific needs.

### SUMMARY OF THE INVENTION

The present invention is an improved data transfer system designed to provide a user with the ability to create a customized subset of particular aircraft, a personalized fleet list, which is formatted as a subset and entered into a list thereby to enable advanced functionality not otherwise available. The ability to customize fleet lists provides users with access to automated data transfers for subset queries. The automated data include but are not limited to user defined view filtering, flight plan updates and notification, positioning, and status change notifications.

Other objects, adaptabilities and capabilities will appear as the description progresses, reference being had to the accompany specification which is incorporated into, and constitutes an improved version of the FLIGHT EXPLORER computer software program and which is incorporated herein by reference. A source code for such software is appended hereto.

### BRIEF DESCRIPTION OF THE DRAWINGS

FIG. 1 is a visual graphic presentation which illustrates data which are provided for a single aircraft of a subset of aircraft in accordance with the invention.

FIG. 2 is a visual graphic representation of data of a subset provided in accordance with the invention.

### DETAILED DESCRIPTION OF THE PREFERRED EMBODIMENTS

The preferred embodiments of the present invention system and method, when introduced into FLIGHT EXPLORER computer software, provide for a user to enter a subset of known aircraft through the use of a toolbar button and dialogue features within a window environment computer software program thereby enabling the interrogation and research of current data on the defined subset of aircraft for user defined enhanced functionality.

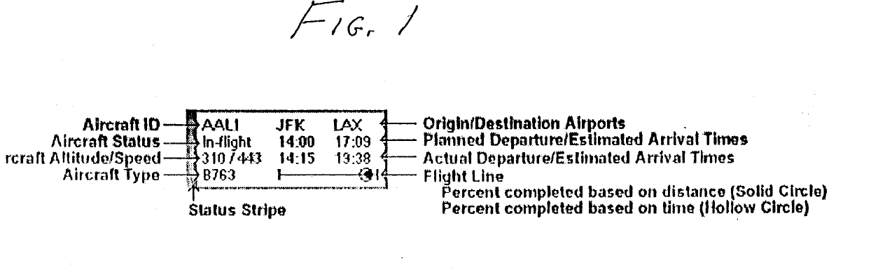

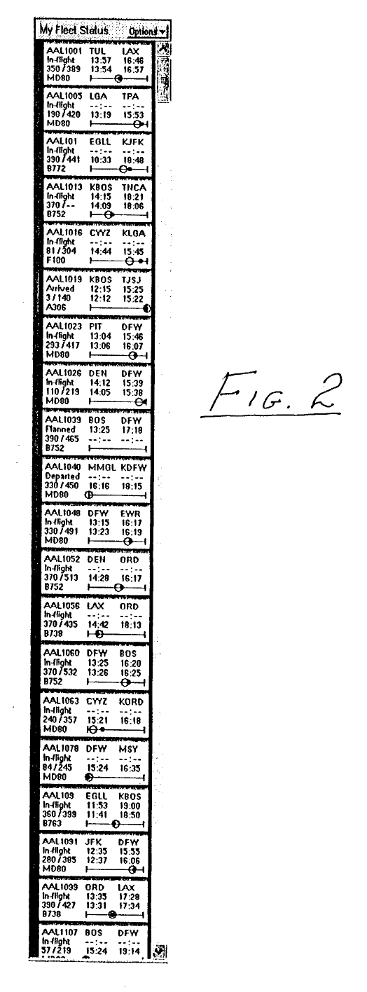

In a preferred embodiment a flight line provides a graphical presentation of the status of a flight in terms of percentage of completion. As show in FIG. 1, a solid circle is used as approximate indicator of the current distance between the departure and arrival airports. A hollow circle as in FIG. 1 is used as an approximate indicator for the current amount of flight time completed by an aircraft between the departure time and estimated time of arrival. Different graphical representations may, of course, be used as indicators of the percentage of completion for time and distance. The indicators may be overlaid or presented side by side. The preferred embodiment of displaying the indicators as shown in FIG. 2 provides a more efficient graphic interface and further provides greater viewing space for a particular subset. The graphic visual also provides quicker feedback in determining the status of a subset compared to prior art interfaces which provide numerical data. Although numerical data such as time and distances may be provided simultaneously with the visual graphic representations, the visuals eliminate the need for calculating math to determine discrepancies in arrival and departure times. The invention provides in lieu thereof quick visual representations of actual disposition of aircraft in a particular flight both time-wise and distance-wise. They may include historical averages of such information for the same flight for comparison purposes.

In another preferred embodiment, a status stripe is colored to indicate further the particular status of a aircraft within a subset or, in other words, a subset within a subset. For, example, all flights which are currently in the air in a particular subset may have a colored side status stripe of blue which thus readily distinguishes them from aircraft for selected flights which are on the ground. Color stripes can be customized to user-defined status entries, such as flight more than ten minutes behind schedule may bear an orange stripe which may change to blue during flight if a tail-wind brings the flight back within an on-time range. Additional colors are used for various status entries of an aircraft from pre-departure through the arrival and de-planed status.

The combination of a colored status stripe and a flight line provides the user with a quick and more efficient graphical status overview of all the flights in a subset.

The advantage of the invention exists because of the excessive number of objects or data sets that are available for collection or processing whereby it is often impractical, if not impossible, fully to process all of the objects due to processing or memory limitations. However, the invention permits the user quickly and easily to identify a pre-defined subset of objects for the whole set which may be available so that the pre-defined sets can be automatically processed as directed by the user. This approach to pre-defined a specific subset of objects has been utilized as an important aspect of the invention. The user thus provides a preset of the parameters it desires to employ and once this has been accomplished the invention functions automatically and independently to operate without further user intervention. The user, of course, has the option at any time to disable or enable the inventive function or to change its operating parameters. More specifically, the invention permits the user to define the subset of aircraft in the user's fleet or the aircraft which the user wishes to monitor and then to apply to the selected subset of aircraft advanced features such as automatic view filtering, automatic flight plan update and display, automatic last known position tracking, and so on.

Preferably a computer program is provided with the dialogue box, whereby by pressing an appropriate tool bar button (say, “MY FLEET”) or by selecting “MY FLEET” from the “Tools” menu, the subset of interest to the user is displayed. Moreover, based on the pre-defined subset and the parameters applied thereto, the user's personal fleet list is displayed. Of course, means are provided for adding, modifying and deleting entries form this list. Aircraft entered into the list shown in the display are programmed for advanced functionality which include automatic user defined view filtering, automatic flight plan update and notification, automatic last known position, and automatic status change notification. The information concerning the aircraft may be displayed and manipulated according to a variety of parameters. These include sorting the subset by aircraft identification first and then by status or vice versa, sorting the subset by estimated departure time or by estimated time of arrival, sorting the subset by ascending order, or by descending order, sorting the subset by distances from destination and displaying all information for a given flight.

Referring to FIG. 1, the flight line provides a graphical presentation of the status of the flight concerned in terms of percentage of completion. Thus the solid circle is an approximate indication of the current distance between departure and arrival airports. The hollow circle is an approximate indication of the current amount of flight time completed since departure time and the estimated time of arrival, and the position of the solid circle in or relative to the hollow circle provides an approximate indication of whether the aircraft is ahead of or behind its expected position in terms of time in flight.

Source code
The following is source code for the My Fleet feature as currently implemented in Flight
Explorer.

```
BOOL CALLBACK Dlg_MyFleet( HWND hDlg, UINT msg, UINT wParam, LPARAM
lParam )
{
        static HWND hList;
    LV_ITEM sItem;
    int iItem;
    switch( msg )
    {
        case WM_INITDIALOG:
        {
        // Initialize filter list
        char pcTemp[10];
        LV_COLUMN sCol;
        int y;
        hList = GetDlgItem(hDlg, IDC_MyFleetList);
        ListView_SetExtendedListViewStyleEx(hList,
                LVS_EX_FULLROWSELECT | LVS_EX_GRIDLINES,
            LVS_EX_FULLROWSELECT | LVS_EX_GRIDLINES);
        // Create columns
        #define MF_COLUMN_COUNT 1
        sCol.mask = LVCF_FMT | LVCF_WIDTH |LVCF_TEXT | LVCF_SUBITEM;
        sCol.fmt = LVCFMT_LEFT;
        sCol.iSubItem = 0;
                sCol.cx = 322;
        sCol.pszText = “Aircraft ID / tail number”;
        ListView_InsertColumn(hList, 0, &sCol);
        ListView_SetItemCount(hList, MF_MAX);
        sItem.mask = LVIF_TEXT | LVIF_PARAM;
            for(int dd = 0; dd < MF_MAX; dd++)
        {
            if( psSysSet->psMyFleetList[dd].pcACID[0] == ‘ ’ )
                break;
            AddMFFilterItem(hList, &(psSysSet->psMyFleetList[dd]), dd,
                    dd, 0);
        }
        CenterWindow(hDlg, GetParent(hDlg), FALSE);
        SetFocus(GetDlgItem(hDlg, IDC_MFNewACID));
            return FALSE;
    }
    case WM_COMMAND:
    {
                switch( wParam )
        {
            case IDC_MFUp:
            case IDC_MFDn:
            {
                    int iCurSel, iToSel;
                int iCurIndex, iToIndex;
                int iTop;
                LV_ITEM sItem;
                    MF_ACID sFilter;
                            iCurSel = ListView_GetNextItem(hList, −1,
LVNI_SELECTED);
                if( iCurSel == −1 )
                {
                    MessageBox(hDlg, “You must first select an entry in the
list.”,
                                “Up/dn error”,
                                MB_ICONINFORMATION | MB_OK);
                    return TRUE;
                }
            // Return if there is no place to go
            if( ((wParam == IDC_MFUp) && (iCurSel == 0)) ∥
                ((wParam == IDC_MFDn) && (iCurSel ==
ListView_GetItemCount(hList))) )
                return TRUE;
            if( wParam == IDC_MFUp )
                iToSel = iCurSel − 1;
            else
                iToSel = iCurSel + 1;
            // Get cur item index
                        sItem.iItem = iCurSel;
            sItem.iSubItem = 0;
            sItem.mask = LVIF_PARAM;
                        ListView_GetItem(hList, &sItem);
            iCurIndex = sItem.lParam;
            // Get To item index
                        sItem.iItem = iToSel;
            sItem.iSubItem = 0;
            sItem.mask = LVIF_PARAM;
                        ListView_GetItem(hList, &sItem);
            iToIndex = sItem.lParam;
            // Update filter array
            memcpy(&sFilter, &(psSysSet->psMyFleetList[iCurIndex]),
sizeof(MF_ACID));
            memcpy(&(psSysSet->psMyFleetList[iCurIndex]),
                    &(psSysSet->psMyFleetList[iToIndex]),
sizeof(MF_ACID));
            memcpy(&(psSysSet->psMyFleetList[iToIndex]), &sFilter,
sizeof(MF_ACID));
            // Update filter list
                        AddMFFilterItem(hList, &(psSysSet-
>psMyFleetList[iCurIndex]), iCurSel,
                    iCurIndex, 1);
                        AddMFFilterItem(hList, &(psSysSet-
>psMyFleetList[iToIndex]), iToSel,
                    iToIndex, 1);
                iTop = ListView_GetTopIndex(hList);
            ListView_RedrawItems(hList, iTop, iTop +
                    ListView_GetCountPerPage(hList));
            UpdateWindow(hList);
                        ListView_SetItemState(hList, iToSel,
LVNI_SELECTED, LVNI_SELECTED);
            return TRUE;
        }
            case IDC_MFAdd:
        {
                // Add new filter; find open slot
            int iIndex;
            int dd;
            int iTop;
            char pcTemp[11];
            char pcTemp2[11];
            // Get new entry
            GetDlgItemText(hDlg, IDC_MFNewACID, pcTemp, 10);
            Null2Pad(pcTemp2, pcTemp, 7);
                        iIndex = −1;
            // Find free filter slot
            for(dd=0; dd<MF_MAX; dd++)
            {
                if( memcmp(psSysSet->psMyFleetList[dd].pcACID, pcTemp2,
7) == 0 )
                {
                    MessageBox(hDlg, “Cannot add ID to My Fleet
list.♯n♯n”
                                    “The aircraft ID/tail
number you have entered is already in the My Fleet list.”,
                            “Add error”,
                        MB_ICONERROR | MB_OK);
                    return TRUE;
                }
                if( psSysSet->psMyFleetList[dd].pcACID[0] == ‘ ’ )
                {
                    iIndex = dd;
                    break;
                }
            }
            if( iIndex == −1 )
            {
                MessageBox(hDlg, “Cannot add entry to the selection
list.♯n♯n”
                            “You have defined the maximum
number of My Fleet entries.”,
                        “Add error”,
                        MB_ICONERROR | MB_OK);
                return TRUE;
            }
            // Add it to the list
            memcpy(psSysSet->psMyFleetList[iIndex].pcACID, pcTemp2,
7);
                    AddMFFilterItem(hList, &(psSysSet-
>psMyFleetList[iIndex]), iIndex, iIndex, 0);
                iTop = ListView_GetTopIndex(hList);
            ListView_RedrawItems(hList, iTop, iTop +
                    ListView_GetCountPerPage(hList));
            UpdateWindow(hList);
            SetDlgItemText(hDlg, IDC_MFNewACID, “”);
                    SetFocus(GetDlgItem(hDlg, IDC_MFNewACID));
            return TRUE;
        }
            case IDC_MFRemove:
        {
                // Delete currently selected filter
            int iCurSel;
                    LV_ITEM sItem;
            int iIndex;
            LV_FINDINFO sFind;
            int dd;
            // Get current selection
                        iCurSel = ListView_GetNextItem(hList, −1,
LVNI_SELECTED);
            if( iCurSel == −1 )
            {
                MessageBox(hDlg, “You must first select a entry in the
list.”,
                        “Remove error”,
                        MB_ICONINFORMATION | MB_OK);
                return TRUE;
            }
            // Find filter index
                    sItem.iItem = iCurSel;
            sItem.iSubItem = 0;
            sItem.mask = LVIF_PARAM;
                    ListView_GetItem(hList, &sItem);
            // Disable filter
            iIndex = sItem.lParam;
            FillMemory(&(psSysSet->psMyFleetList[iIndex].pcACID),
sizeof(MF_ACID), ‘ ’);
            // Remove filter from list
            ListView_DeleteItem(hList, iCurSel);
            // Shift all other items up one in the list
                        for(dd=iIndex + 1; dd<MF_MAX; dd++)
            {
                            if( psSysSet-
>psMyFleetList[dd].pcACID[0] == ‘ ’ )
                    break;
                // Copy filter data
                memcpy(psSysSet->psMyFleetList[iIndex].pcACID,
                            psSysSet->psMyFleetList[dd].pcACID,
sizeof(MF_ACID));
                    FillMemory(&(psSysSet->psMyFleetList[dd].pcACID),
sizeof(MF_ACID), ‘ ’);
                // Reset lParam in list view
                sFind.flags = LVFI_PARAM;
                sFind.lParam = dd;
                iCurSel = ListView_FindItem(hList, −1, &sFind);
                sItem.iItem = iCurSel;
                sItem.iSubItem = 0;
                sItem.mask = LVIF_PARAM;
                sItem.lParam = iIndex;
                ListView_SetItem(hList, &sItem);
                iIndex++;
            }
            return TRUE;
        }
                    case IDOK:
                            ReFilterAllPlanes();
                            EndDialog(hDlg, 0);
                        return TRUE;
                    case IDCANCEL:
                            EndDialog(hDlg, 1);
                        return TRUE;
                    case IDHELP:
                                HtmlHelp(hDlg, HELP_FILE_NAME, HH_HELP_CONTEXT,
IDH_MyFleet);
                            return TRUE;
                }
                return FALSE;
            }
                case WM_NOTIFY:
                    {
                    LV_DISPINFO *pLvdi = (LV_DISPINFO *) lParam;
                            NM_LISTVIEW *pNM = (NM_LISTVIEW *) lParam;
                int Index = pLvdi->item.lParam;
// MF_ACID *psMFEntry = psSysSet->psMyFleetList + pLvdi-
>item.lParam;
                if( pNM->hdr.hwndFrom != hList )
                    return 0L;
                switch( pNM->hdr.code )
                {
                                case LVN_GETDISPINFO:
                    {
                            static char pcTemp[240];
                        static int iTemp = 160;
                        // Rotate 3 buffers
                        iTemp += 80;
                        if( iTemp == 240 )
                            iTemp = 0;
                        Pad2Null(pcTemp + iTemp, psSysSet-
>psMyFleetList[iIndex].pcACID, 7);
// GetPlaneItem(psPlane2, pLvdi-
>item.iSubItem, pcTemp + iTemp);
                            pLvdi->item.pszText = pcTemp + iTemp;
                                        wsprintf(pcEvent, “Requested: %d”, iIndex);
                        LogEvent(pcEvent, EV_DEBUG);
                            break;
                    }
                }
                return 0L;
            }
        }
        return FALSE;
    }
    // cToDo: 0=insert, 1=update
    bool AddMFFilterItem( HWND hList, MF_ACID *psFilter, int iItem, int
    iIndex,
                BYTE cToDo )
    {
            LV_ITEM sItem;
        char pcTemp[100];
        char pcT1[30];
        char pcT2[30];
        int iTemp;
            sItem.iItem = iItem;
        sItem.mask = LVIF_TEXT | LVIF_PARAM;
        sItem.iSubItem = 0;
        Pad2Null(pcT1, psFilter->pcACID, 7);
        iTemp = ((7 − strlen(pcT1)) * 2) + 2;
        if( pcT1[0] == 0 )
        {
            pcT1[0] = ‘*’;
            pcT1[1] = 0;
        }
        sprintf(pcTemp, “%s%.*s”, pcT1, iTemp, “ ”);
        sItem.pszText = pcTemp;
            sItem.lParam = iIndex;
            if( cToDo = 0 )
                ListView_InsertItem(hList, &sItem);
        else
            ListView_SetItem(hList, &sItem);
        return true;
    }
```

Referring to FIG. 2, the strip on the left side of the subset of aircraft is, in fact a colored strip for each flight which indicates the event associated by that flight by the color such as whether the aircraft is in route, ascending from its departure airport, descending into its arrival airport, or on the ground. The combination of the status stripe and flight lines provide the user with a quick graphical status overview of all of the flights in the subset involved.

The program is devised so that clicking on the flight stripe provides the viewer with a list of selected events related to the aircraft. By clicking on the flight stripe, detailed information is provided on aircraft identification, airline, arrival and departure airports, aircraft speed, aircraft altitude, arrival departure times, route text, and position history.

Viewers can also be provided, via programming therefor, connection to appropriate data sources with further functions such as alerts, flight plan and last known position information:

Although I have disclosed the preferred embodiments of my invention, it is to be understood that it is capable of other adaptations and modifications within the scope of the following claims:

1. A method of selecting data from general aircraft operations data comprising creating subsets of user identified aircraft for automatic user identified information and functionality.

2. A method in accordance with claim 1 further comprising automatic status change notification of aircraft in each said subset, which is graphically represented by a color stripe adjacent to information relating to aircraft in said subset.

3. A method in accordance with claim 1 further comprising automatic status change notification of aircraft in each said subset which graphically represents the percentage completed of a flight of said aircraft based on time.

4. A method in accordance with claim 1 further comprising automatic status change notification of aircraft in each said subset which graphically represents the route percentage completed of a flight of said aircraft based on distance.

5. A method in accordance with claim 1 further comprising automatic status change notification of aircraft in each said subset graphically representing the route percentage completed of each aircraft based on time and distance.
